(19) United States
(12) Patent Application Publication
(10) Pub. No.: US 2023/0180943 A1
(43) Pub. Date: Jun. 15, 2023

(54) Adjustable Mattress For Recovery After Lower Trunk Surgical And Other Procedures

(71) Applicants: Demiana Kerlus, Las Vegas, NV (US); Christopher Modina, Las Vegas, NV (US)

(72) Inventors: Demiana Kerlus, Las Vegas, NV (US); Christopher Modina, Las Vegas, NV (US)

(21) Appl. No.: 17/550,742

(22) Filed: Dec. 14, 2021

(51) Int. Cl. A47C 27/14; A47C 27/10; A61G 7/057

(52) U.S. Cl. CPC A47C 27/146; A47C 27/10; A61G 7/05769; A61G 2200/327

(57) ABSTRACT

The present invention is directed to a mattress which is useful for people who have had gluteal surgery such as but not limited to gluteoplasty, commonly known as a Brazilian Butt Lift, Butt Implants, Fat Transfer, Fat Grafting, Liposuction, Pilonidal cystectomy, or other procedures affecting the lower rear area of a human trunk, which result in a person being uncomfortable when lying supine or sitting after the surgery or other procedure. The mattress in certain embodiments has an opening with at least one tube-shaped cushion which is adjustable for people with different body sizes and stages of recovery. The at least one tube-shaped cushion may be continuous, toroidal, round, square, rectangular, triangular, or any regular or irregular shape that would fit the buttocks. The at least one tube-shaped cushion may be inflatable, detachable, or permanently affixed in the opening. The mattress in certain embodiments may have the at least one tube-shaped cushion concentrically placed. The mattress in certain embodiments may have a raised back support for comfort along with a raised foot support to reduce the chance of blood clots. In other embodiments, the mattress can have an opening on a top or first side and a larger opening on a bottom or second side so that the mattress is reversible to accommodate different body sizes and stages of recovery. In other embodiments, the mattress may have at least one tube-shaped cushion in an opening on a top or first side and a larger opening on a bottom or second side to accommodate different body sizes and different stages of recovery. In other embodiments, the mattress may have a lumbar and thigh support which may be adjustable. The mattress and the tube-shaped cushion may be self-inflating in the case that they are inflatable.

### TECHNICAL FIELD

The present invention relates generally to the field of mattresses and beds, and more particularly to mattresses for supporting post-surgical and other procedures which require patients to avoid putting pressure on the buttocks and lower trunk when sitting or lying supine.

### BACKGROUND

The following is a tabulation of some references that provide background:

U.S. Patents

| Patent Number | Kind Code | Issue Date | Patentee |
|---|---|---|---|
| U.S. Pat. No. 4,819,287 | | 1989 | Halverson |
| U.S. Pat. No. 6,959,464 | B2 | 2005 | Fahey |
| U.S. Pat. No. 7,127,764 | B1 | 2006 | Harding et al. |
| U.S. Pat. No. 7,849,544 | B2 | 2010 | Flocard et al. |
| US 10,051,972 | B2 | 2018 | Nakamura et al |

U.S. Patent Application Publications

| Publication Nr. | Kind Code | Publ. Date | Applicant |
|---|---|---|---|
| US 2013/0283526 | A1 | Oct. 31, 2013 | Gagliardi |
| US 2017/0071357 | A1 | Mar. 16, 2017 | Zanki et al. |

Other References
https://www.recoverybae.ca/products/bbl-inflatable-mattress
https://www.bootybeanbag.com/

Surgical procedures of the lower trunk, such as but not limited to gluteoplasty, commonly known as a Brazilian Butt Lift, Butt Implants, Fat Transfer, Fat Grafting, Liposuction, Pilonidal cystectomy, and abdominoplasty (e.g., a tummy tuck), or other procedures affecting the lower area of a human trunk, require a patient to avoid sitting, lying, or otherwise putting excessive pressure on their gluteal and lower trunk area for a minimum of four to six weeks after the surgery or other procedure. Putting excessive pressure on these areas of the body may negatively alter the results of the surgery or procedure, and/or the person's recovery. In the event that a patient has a gluteoplasty along with abdominoplasty, commonly known as a tummy tuck, the patient would have extremely limited options for sleep in a traditional bed.

Air mattresses as well as custom fill mattresses have been commonly found in the art for decades. Typically, air mattresses are made up of a plurality of chambers or channels with heat seal seams and are comprised of plastic or plasticized canvas materials with a single inflation nozzle whereby air is blown into the mattress to inflate all the chambers. U.S. Pat. No. 7,849,544 issued 2010 to Flocard et al. was directed at an inflatable mattress that regulates pressure to increase support to the sacrum of an individual. This would not be appropriate for someone recovering from gluteal surgery because it would put excessive pressure on the gluteal and/or the lower trunk area when lying supine. U.S. Pat. No. 10,051,927 issued 2018 to Nakamura et al. supports the human body with cells which are filled with fluid chambers, and similarly would put pressure on the gluteal area when lying supine.

Mattresses for pregnant women have various methods of allowing space for lying prone during pregnancy. U.S. Pat. No. 4,819,287 issued 1989 to Halvorson was directed to a flat mattress with a plurality of cushions serially arranged within one another in an opening for the belly, at least one of which is non-inflatable foam to provide structural support for the pregnant belly. This would not be suitable for gluteal surgery recuperation because the gluteal area does not need the same structural support as a pregnant belly. The gluteal area cannot have excessive pressure on it at all during recovery whereas the pregnant belly requires support.

U.S. Pat. No. 6,959,464 issued 2005 to Fahey was directed to a flat air mattress with a rectangular opening with detachable bolsters to use for bathing the pregnant belly in water at a pool or at a beach. U.S. Pat. No. 7,127,764 issued 2006 to Harding et al. teaches a mattress with a bellows forming a womb well. The bellows is formed by accordion-like sections and fine tuned to firmness of the womb well region. Therapeutic beds with recesses for pregnant or obese people lying prone are taught in Publication US 2013/0283526 by inventor Gagliardi. Other art such as Publication US 2017/0071357 show a raised ring to support the belly of an obese or pregnant person. This would be inappropriate for someone recovering from gluteal surgery.

Air mattresses advertised as for Brazilian Butt Lift are available online for purchase. These mattresses are consistently flat so that they do not decrease the possibility of blood clots. Also, the opening for the gluteal area is not adjustable for different sized bodies and different stages of recovery. These mattresses lack adequate adjustability to particular patients and their size, shape and different needs during recovery.

There is a need for a mattress that can be used after gluteal surgery, or other surgery and procedures (e.g., injections) affecting the lower area of a human trunk, that may be adjustable for different sized bodies and different stages of recovery, and which may avoid or minimize putting excessive pressure on the gluteal area or other parts of the lower rear area of a person when lying supine or sitting.

### SUMMARY OF THE INVENTION

Certain embodiments of this invention comprise an adjustable mattress that avoids putting excessive pressure on the gluteal area or other parts of the lower area of a person who is lying supine or sitting. Preferred embodiments comprise mattresses that are adjustable for different sized bodies and different stages of recovery.

The term “mattress” as used herein refers to a device that may resemble a conventional bed mattress in many respects and which may be used with a conventional bed, on top of, in addition to, or as a replacement for, a conventional mattress and/or mattress box spring set, or it may be stand alone and be placed on the floor of a room. In alternative embodiments, the mattress term refers to what more closely resembles a bed (e.g., an inflatable bed) and it may be stand alone and not be used with a conventional bed at all but instead it may be placed directly on the floor of a room.

The mattress of this invention will contain at least one opening, generally found in the middle of the mattress where a person's buttocks would normally be found when the person is lying supine. In certain embodiments of this invention, the size and shape of the opening can be adjusted to fit a particular person immediately after a medical procedure and/or as the person recovers from the procedure.

In certain embodiments, the mattress opening has one or more tube-shaped cushions contained therein. In certain preferred embodiments of these, the tube-shaped cushions are continuous (e.g., forming a donut shape or round shape without beginning or end). These cushions, alone or together, may preferably add between about 0.5 to about 6 inches or more to the opening in the mattress, and more preferably about 1 to about 3 inches to the opening in the mattress, and most preferably about 2 inches to the opening in the mattress. In other preferred embodiments, the tube-shaped cushions are not continuous and multiple cushions are used (e.g., one or more on the left side of the patient and one or more on the right side of the patient; one or more on the front of the patient and one or more on the back of the patient) and instead of being one continuous shape, each cushion has at least two ends.

In certain alternative embodiments, there are multiple tube-shaped cushions that are all available to be used together, although in some applications only some may be used together, in order to better fit a person after their surgery or other procedure. These cushions can be filled with air, liquid, or any other substance using valves or other hardware or devices and have single or multiple compartments and/or channels. In certain of these embodiments, the multiple cushions can be adjustable by, for example, adding or subtracting air or liquid from them. Thus, a series of such cushions can be used that fit within each other and/or the mattress and they can be adjusted in size, shape and/or other properties (e.g., firmness) to better fit the person and their needs. The shape of such cushions also can be of the same shape or they can differ in order to provide a better fit for the particular person using the mattress.

In still other alternative embodiments, the tube-shaped cushions can have multiple tubing layers that can be used. These cushions can be filled with air, liquid, or any other substance, and have single or multiple compartments and/or channels. In certain of these embodiments, the different tubing layers can be inflated or filled separately to provide additional methods to adjust their fit and application to individual persons.

In certain embodiments, instead of separate tube-shaped cushions, the mattress has separate layers, compartments and/or channels built into the opening of the mattress that can be each separately filled with air and/or liquid and/or any other substance through valves or other hardware or devices to adjust them to a particular person's needs.

Each of the tube-shaped cushion may be inflatable in certain embodiments. If they are inflatable, they may have at least one valve or other hardware or device for inflating them. They may also have multiple valves and multiple channels or compartments to increase their ability to be adjusted for particular patients. Such a valve or similar device should be placed in a position so as to not make the person using the mattress uncomfortable. In some embodiments, the tube-shaped cushion is self-inflatable. In preferred embodiments the cushion is adjustable in its size, firmness and/or other properties so that it can be adjusted to provide better comfort for the person using it. In other preferred embodiments, a variety of cushions with different sizes, firmness and/or other properties is provided that all fit the mattress (or each other), which can be chosen based on their ability to increase the comfort and fit for the person using them and be changed, if necessary, as the person's recovery progresses and/or needs change.

In a first illustrative embodiment, a mattress has at least one tube-shaped cushion that is preferably continuous which may be inflated to different sizes and different levels of firmness.

In a second illustrative embodiment, a mattress has at least one tube-shaped cushion which may be inflated which is removably attached.

In a third illustrative embodiment a mattress has at least one tube-shaped cushion which may be inflated which is permanently attached.

In a fourth illustrative embodiment, a mattress has a raised head support and a raised foot support along with at least one tube-shaped cushion which may be inflated.

In a fifth illustrative embodiment, a mattress is an inflatable air mattress.

In a sixth illustrative embodiment, a mattress has at least one tube-shaped cushion which is self-inflating.

In a seventh illustrative embodiment, a mattress is self-inflating and has at least one tube-shaped cushion which may be inflated.

In an eighth illustrative embodiment, a mattress has different sized openings on top (or a first side) and bottom (or a second side) of the mattress making it reversible. This embodiment may or may not have at least one tube-shaped cushion.

In a ninth illustrative embodiment, the mattress is chair shaped, with or without at least one adjustable tube-shaped cushion, and may or may not have a foot stool.

In a tenth illustrative embodiment, the mattress has adjustable lumbar and thigh support. The aforementioned embodiments can be used alone in a mattress of this invention or two or more of the embodiments can be combined together in a mattress of this invention. The numbering used in describing these embodiments above is for illustrative purposes only.

One or more potential advantages or desired aspects of this invention can be obtained by certain of the embodiments when a patient has undergone a Brazilian Butt Lift, Butt Implants, Fat Transfer, Fat Grafting, Liposuction, Pilonidal cystectomy, or other procedure affecting the lower area of a human trunk, including an abdominoplasty, and the patient is not comfortable putting significant or otherwise excessive (or any) pressure on their gluteal area during the recovery period. Such excessive weight put on the lower area of a human trunk may also negatively alter the results of the surgery or procedure. In addition, excessive pressure on the lower area of the human trunk may result in less blood flow to the area (e.g., buttocks), which can impact the survival of the involved cells and tissues, including transferred fat cells, thus affecting the main purpose of the surgery or other procedure. Preferred embodiments of the present invention allow the patient to sit or lie supine without putting significant or otherwise excessive pressure on the area of the surgery or other procedure. The adjustable mattress for gluteal and other procedures of this invention can provide ergonomic comfort for the patient and promote healing.

The present invention includes embodiments that comprise a mattress with a tube-shaped cushion, which is preferably adjustable in size and firmness, to adjust the size of an opening for people that have different hip sizes. The continuous tube-shaped cushion of certain embodiments may be inflatable to a person's preference and size, which may change during the healing process. The mattress of certain embodiments may be adjustably elevated in a back area to improve comfort and/or adjustably elevated in a foot area to prevent blood clots. In certain preferred embodiments, the mattress may also include an adjustable lumbar support. In certain preferred embodiments, the opening in the mattress can be capable of alleviating the effects from placing some or all of a person's weight on the person's buttocks. In other preferred embodiments, a mattress has different sized openings on the top (a first side) and bottom (a second side) of the mattress making it reversible for thinner and wider hips, along with versatility in order to be adjusted to conform to a person's different stages of recovery. Certain of these embodiments may or may not include at least one tube-shaped cushion, such as a continuous tube-shaped cushion, which, in the most preferred embodiments, is adjustable as to size, firmness and/or other properties to provide better fit for particular patients after surgery and other procedures and as they recover. The various advantages and desired aspects of the different embodiments can be combined in a mattress of this invention by adopting one or more of the embodiments in the mattress. Other advantages of one or more aspects of this invention will be apparent from a consideration of the drawings and the ensuing description.

### BRIEF DESCRIPTION OF THE DRAWINGS

FIG. 1 is a schematic and a perspective view of an embodiment of the invention.

FIG. 2 is a schematic and a side view of a preferred embodiment of the invention, showing a person utilizing the embodiment.

FIG. 3 is a schematic and a perspective view of an embodiment of the invention wherein the mattress is an air mattress.

FIG. 4 is a schematic and a perspective view of an embodiment of the invention showing the bottom of the embodiment.

FIG. 5 is a schematic and a perspective view of an embodiment of the invention showing the top of the embodiment from FIG. 4.

FIG. 6 is a schematic and a perspective view of an embodiment of the invention wherein the continuous tube-shaped cushion is attachable by hook and loop tape.

FIG. 7 is a schematic and a perspective view of an embodiment of the invention wherein the mattress is a self-inflating air mattress.

FIG. 8 is a schematic and a perspective view of an embodiment of the invention showing a continuous tube-shaped cushion wherein the continuous tube-shaped cushion is self-inflating by use of an air pump.

FIG. 9 is a schematic and a cut-out view of an embodiment of the invention showing a continuous tube-shaped cushion wherein the continuous tube-shaped cushion is self-inflating by use of open cell foam.

FIG. 10 is a schematic and a perspective view of an embodiment of the invention that shows a mattress which is chair shaped and which may be used with at least one adjustable tube-shaped cushion.

FIG. 11 is a schematic and a top view of an embodiment of the invention that shows a series of continuous tube-shaped cushions.

FIG. 12 is a schematic and a perspective view an embodiment of the invention wherein the mattress is an inflatable air mattress with one or more non-continuous tube-shaped cushions placed in an opening of the mattress.

FIG. 13 is a schematic and perspective view of the invention wherein the mattress is an inflatable air mattress with lumbar support and thigh support which may be adjustable.

### DETAILED DESCRIPTION OF THE INVENTION

When a patient has undergone a Brazilian Butt Lift, Butt Implants, Fat Transfer, Fat Grafting, Liposuction, Pilonidal cystectomy, or other procedures affecting the lower (e.g., rear) area of a human trunk, the patient may be required to avoid sitting, lying, or otherwise putting significant or otherwise excessive (or any) pressure on their gluteal area during the recovery period. In some instances, avoiding putting any pressure on the gluteal area during the recovery period is desired. In the event that a patient also has a gluteoplasty along with abdominoplasty, commonly known as a tummy tuck, the patient would have extremely limited options for sleeping in a traditional bed. The present invention allows the patient to lie supine and sit without putting excessive pressure on the surgical area. The phrase, “without putting excessive pressure” and similar phrases used herein, mean that the person experiences reduced or no pain or discomfort when they are lying supine or sitting, the person experiences little or no reduction in blood flow to the lower trunk area when lying supine or sitting, and/or the person exerts reduced or no pressure on the gluteal and/or lower trunk area when lying supine or sitting, by virtue of using this invention.

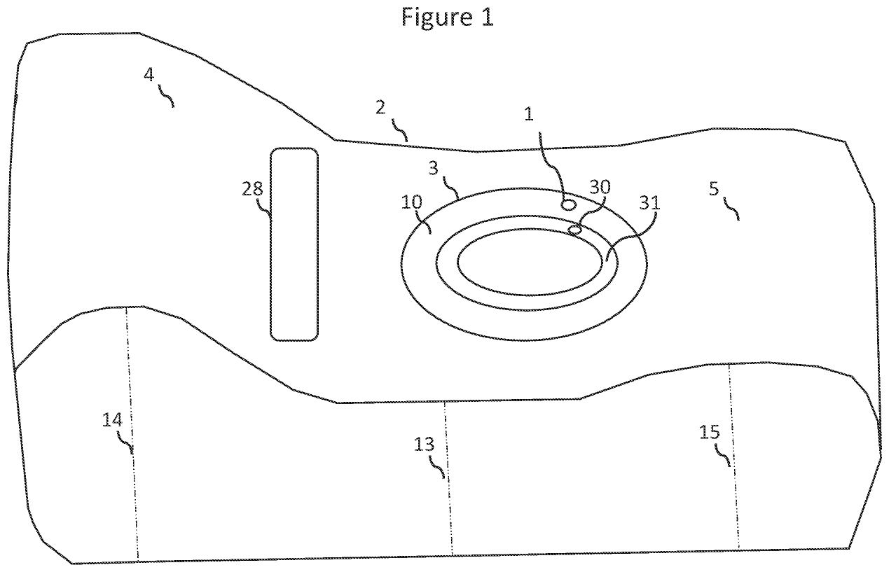

An embodiment of a mattress 2 of this invention is shown in FIG. 1. The mattress 2 has an opening 3 for a continuous tube-shaped cushion 10 in this embodiment. The continuous tube-shaped cushion 10 is shown as toroidal or doughnut-like in structure but this is not intended to limit the shape of the cushion which could be round, square, rectangular, triangular, oval, or any regular or irregular shape that would fit the buttocks. Non-continuous tube-shaped cushions can also be used. The continuous tube-shaped cushion 10 may be inflatable and if inflatable it includes an inflation port 1 (e.g., valve) which is separate from any inflation ports in the mattress 2. Otherwise, the continuous tube-shaped cushion 10 may be composed of foam, memory foam, sponge, gel, or any other type of conventional cushion material. The continuous tube-shaped cushion 10 may be flocked or coated in soft fabric or other material for comfort. In other embodiments, the cushion forms a shape that is not continuous (e.g., is not without beginning or end such as a donut shape), such as a tube in the shape of a horseshoe or the letter “C” or some other shape that a person of skill in the art would understand or learn from this disclosure avoids excessive pressure in a person's gluteal area when the person is lying in a supine position or sitting. In the most preferred embodiments, the cushion may be adjustable in size, firmness and/or other properties (e.g., by adding or subtracting air in an inflatable cushion, adding stiffners, changing the shape) to increase the comfort of the person as the person recovers. In certain embodiments, different shapes and/or sizes of the cushion that each fit the opening in the mattress are provided to provide choices to obtain a better fit for a particular person immediately after surgery or some other procedure and as recovery progresses.

If inflatable, the continuous (or non-continuous) tube-shaped cushion 10 may be comprised of plastic or plasticized canvas materials. The material which is currently preferable is a vinyl plastic such as polyvinyl chloride (i.e., PVC), but polyvinyl chloride polymers, polymers containing the vinyl radical or vinylidene radical, linear polyethylene, nylon, polypropylene, polystyrene, natural materials, and like materials may be used. Other flexible sheet material could also be used, including various types of rubber. Adhesive seals and other types of seals may be used. The tube-shaped cushion may also have a cover, such as a fabric or material cover, and in preferred embodiments the cover is comfortable to the touch. In more preferred embodiments, the cover has minimal heat retaining properties.

The mattress 2 may be inflatable or may be composed of foam, memory foam, sponge, gel, or of any other type of conventional mattress material, including a water mattress. An optional inflation port 1 is in no particular position on the continuous tube-shaped cushion 10, but the inflation port 1 should be designed so as to be pushed in or otherwise not be an impediment or protrusion which would irritate, annoy, or harm the user. The continuous tube-shaped cushion 10 in the present invention is adjustable in size by increasing or decreasing the amount of air in the cushion to suit the size of the person or the person's stage of recovery. A second continuous tube-shaped cushion 31 is shown inside the continuous tube-shaped cushion 10. This second continuous tube-shaped cushion 31 is also shown as an inflatable cushion but may be composed of foam, memory foam, sponge, gel, or any other type of conventional cushion material. The second continuous tube-shaped cushion 31 may be flocked or coated in soft fabric or other material for comfort. The second continuous tube-shaped cushion 31 has an optional separate inflation port 30 so that the second continuous tube-shaped cushion can be inflated or deflated to conform to the comfort and size of the person using the invention. Said inflation port 30 is in no particular position. The second continuous tube-shaped cushion 31 may be self-inflating by using an open cell foam core. The open cell foam core is such that free passage of air is allowed therethrough. When inflation port 30 is opened, the open cell foam core inflates automatically if not manually compressed. Inflation port 30 can be closed after the continuous tube-shaped cushion is inflated to a sufficient size to suit the size of the person and the stage of the person's recovery. Self-inflation by using open cell foam is commonly known in the art.

FIG. 1 shows a perspective view of one embodiment of the present invention wherein a height of the mattress 2 varies along the length of the mattress 2. Included in this embodiment is a lumbar support 28 which may be inflatable or of foam, memory foam, sponge, gel, or any commonly known cushion material. A height of a back support area 4 increases from a height 13 to a height 14 along the length of the mattress 2 for comfort. A height of a foot support area 5 increases from a height 13 to a height 15 along the length of the mattress 2 to raise the feet of the person to decrease the risk of blood clots. As an example, height 14 could be 18 inches, height 13 could be 8 inches, and height 15 could be 12 inches. These heights are provided as an example only and do not preclude other heights and height combinations which may be reasonably used.

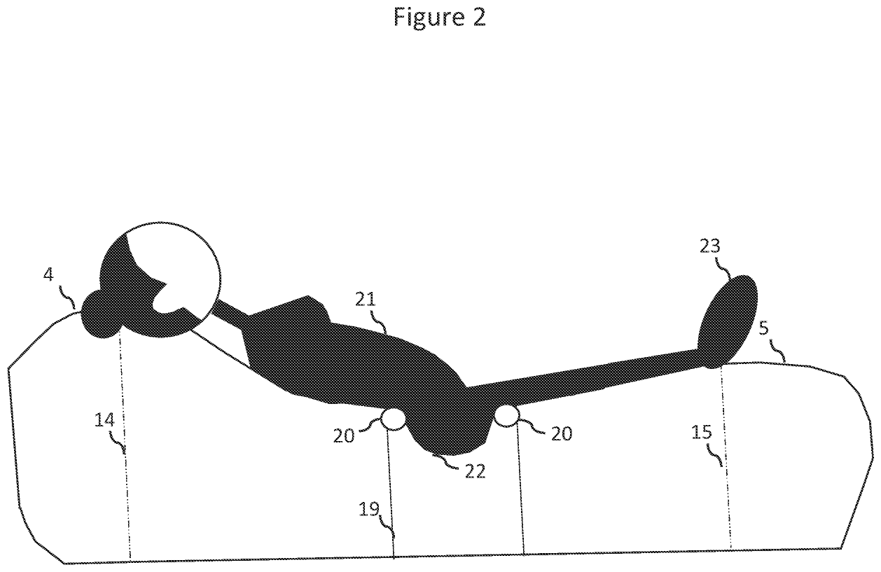

FIG. 2 shows a person 21 lying in a supine position on an embodiment of the mattress 2 of this invention. The person's buttocks 22 are in an opening 19. The person 21 is supported by the continuous tube-shaped cushion shown in cross sections 20. The height 14 of the back support area 4 is enough to make the person comfortable. The height 14 of the back support area 4 may be adjustable by increasing or decreasing the amount of air in the mattress in the event that the mattress 2 is an inflatable mattress. The height 14 of the back support area 4 may be adjustable by any commonly known means in the event that the mattress is of any other conventional mattress material. The height 15 of the foot support area 5 is enough to elevate the person's feet 23 to decrease the risk of blood clots. The height 15 of the foot support area 5 may be adjustable by increasing or decreasing the amount of air in the mattress in the event that the mattress 2 is an inflatable mattress. The height 15 of the foot support area 5 may be adjustable by any commonly known means in the event that the mattress is of any other conventional material.

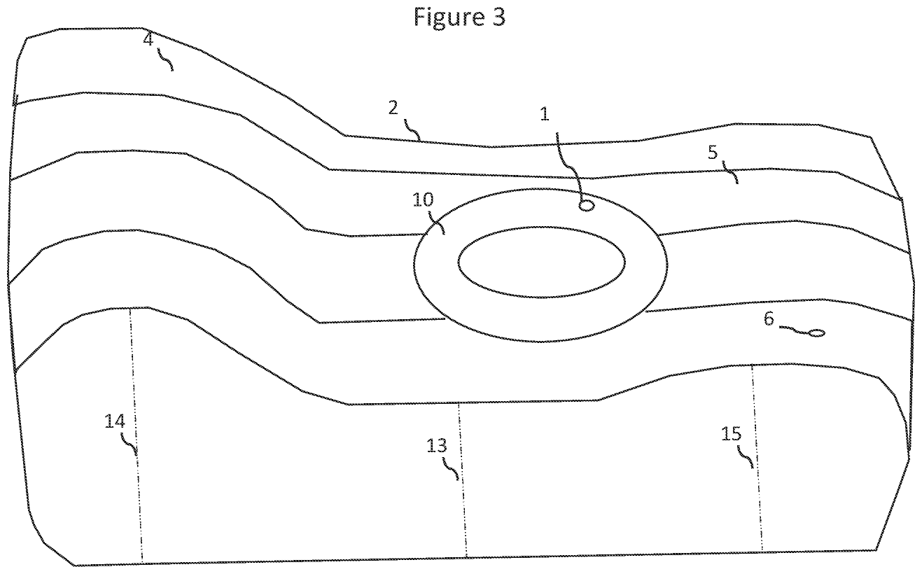

FIG. 3 shows a perspective view of the mattress 2 in which the mattress 2 is an inflatable air mattress. Typically, air mattresses are made up of a plurality of chambers or channels with heat seal seams and are comprised of plastic or plasticized canvas materials. The material which is currently preferable is a vinyl plastic such as polyvinyl chloride (i.e., PVC), but polyvinyl chloride polymers, polymers containing the vinyl radical or vinylidene radical, linear polyethylene, nylon, polypropylene, polystyrene, and like materials may be used. Other flexible sheet material could also be used, including various types of rubber. Adhesive seals and other types of seals may be used. The material used may be flocked or coated in fabric or other material to increase the comfort of the user. The mattress has an optional inflation port 6 which is in no particular position on the mattress 2, but the inflation port 6 if used should be designed so as to be pushed in and not be an impediment or protrusion which would irritate, annoy, or harm the user. If inflatable, the continuous tube-shaped cushion 10 in the present invention is adjustable in size by increasing or decreasing the amount of air in the cushion to suit the size of the person or the person's stage of recovery. The height 14 of the back support area 4 is enough to make the person comfortable. The height 15 of the foot support area 5 is enough to elevate the person's feet 23 to decrease the risk of blood clots. As an example, height 14 could be 18 inches, and height 15 could be 12 inches. These heights are as an example only and do not preclude other heights and height combinations which may be reasonably used.

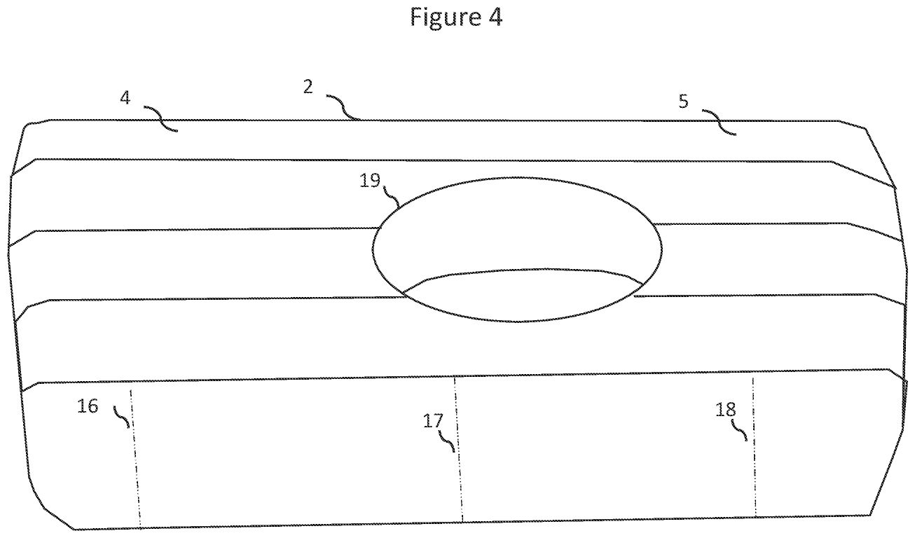

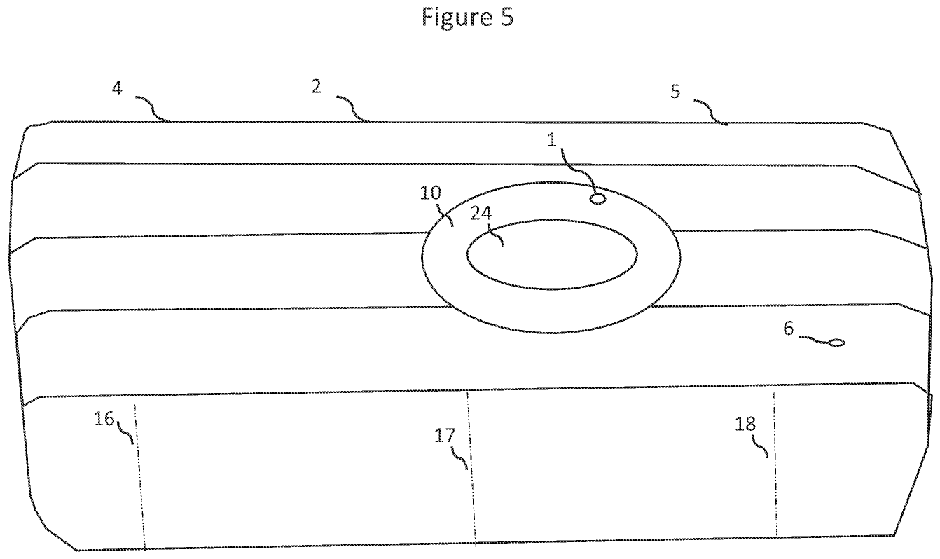

FIG. 4 and FIG. 5 illustrate a reversible mattress which has an opening on one side (FIG. 5) and a larger opening on the other side (FIG. 4). The opening on at least one side of the mattress may contain a continuous tube-shaped cushion 10. FIG. 4 shows a perspective view of a bottom (or second side) of the mattress 2 in an alternative embodiment of the invention. FIG. 5 shows a perspective view of a top (or first side) of the mattress 2 in the alternative embodiment of the invention. As an example, the mattress 2 is depicted as an inflatable mattress, but may be composed of foam, memory foam, gel, or of any other type of conventional mattress material. The optional inflation port 1 is in no particular position on the continuous tube-shaped cushion 10. The inflation port 6 is also in no particular position on the mattress 2. The continuous tube-shaped cushion 10 in the present invention is adjustable by increasing or decreasing the amount of air in the cushion to suit the size of the person or the person's stage of recovery. The opening 19 in FIG. 4 is larger than the opening 24 in FIG. 5 so that the mattress 2 can be flipped upside down to offer more adjustability to suit the size of the person or the person's stage in recovery. The height of the mattress is uniform in this embodiment but may be elevated as in other embodiments such as depicted in FIG. 1. In this embodiment, height 16 of the back support area 4 is the same as height 17 and height 18 of the foot support area 5. The height can be any height that is comfortable for the user.

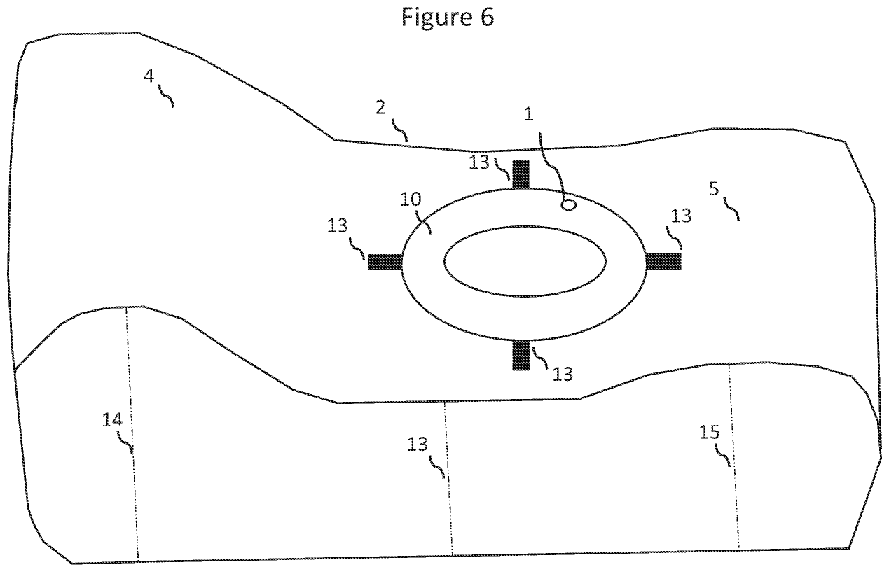

FIG. 6 shows a perspective view of the invention wherein the continuous tube-shaped cushion 10 is detachably attached to the mattress 2 by use of a plurality of hook and loop tape (i.e., Velcro™) 13 permanently attached to both the mattress 2 and the continuous tube-shaped cushion 10. The locations of the hook and loop tape 13 are for illustrative purposes only and the hook and loop tape may be placed anywhere around the continuous tube-shaped cushion 10 so that the continuous tube-shaped cushion 10 is firmly attached to the mattress 2. Also, it should be noted that although hook and loop tape is depicted, other attachment hardware or other means such as padded buttons, hooks, snaps, or any other known attachment hardware or other means could be used. In FIG. 6 the back support area 4 and the foot support area 5 are elevated to height 14 and height 15 respectively. Height 14 and height 15 are higher than height 13. An inflation port 1 is depicted on the continuous tube-shaped cushion 10. The inflation port 1 is in no particular position on the continuous tube-shaped cushion 10.

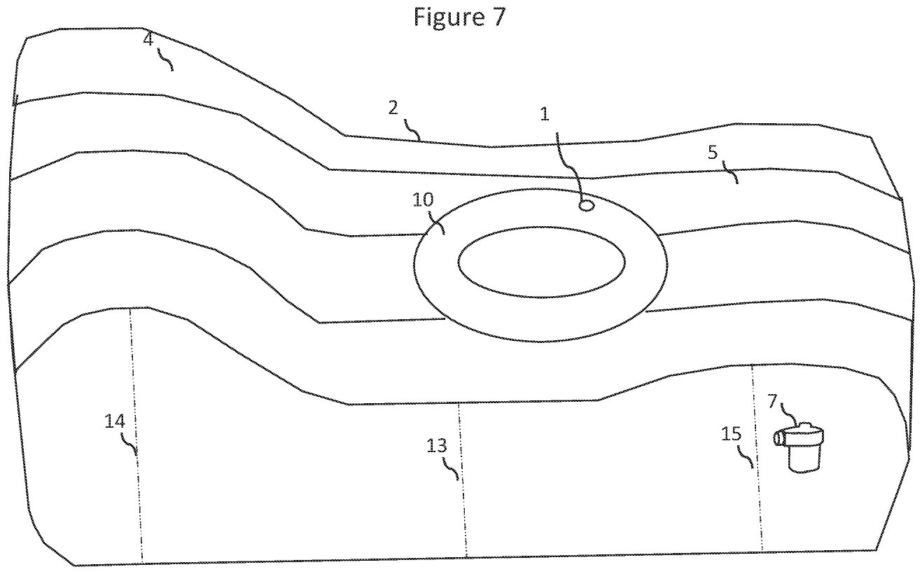

FIG. 7 shows a perspective view of the invention wherein the mattress 2 is a self-inflating air mattress. Air pump 7 may be located internally or externally on mattress 2. The location of the air pump 7 on FIG. 7 is in no particular position on the mattress 2. Air pumps are commonly known in the art, and any such pump could be used with this air mattress. In FIG. 7 the back support area 4 and the foot support area 5 are elevated to height 14 and height 15 respectively. As in FIG. 1, height 14 and height 15 are higher than height 13. An inflation port 1 is depicted on the continuous tube-shaped cushion 10. The inflation port 1 is in no particular position on the continuous tube-shaped cushion 10.

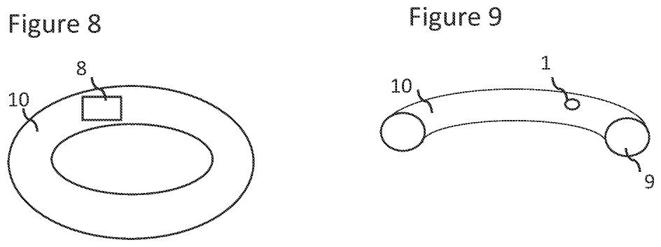

FIG. 8 shows a continuous tube-shaped cushion 10 which is self-inflating. Pump 8 could be located internally or externally in the continuous tube-shaped cushion 10 so as not to irritate, annoy, or harm the user. Air pumps are commonly known in the art and any such pump could be used with this continuous tube-shaped cushion 10 if of sufficiently small size.

FIG. 9 shows a cross section view of a continuous tube-shaped cushion 10 which is self-inflating by using an open cell foam core 9. The open cell foam core 9 is such that free passage of air is allowed throughout the cell foam core 9. When inflation port 1 is opened, the open cell foam core 9 inflates automatically if not manually compressed. Inflation port 1 can be closed after the continuous tube-shaped cushion is inflated to a sufficient size to suit the size of the person and the stage of the person's recovery. Self-inflation by using open cell foam is commonly known in the art. The inflation port 1 is in no particular position on the continuous tube-shaped cushion 10.

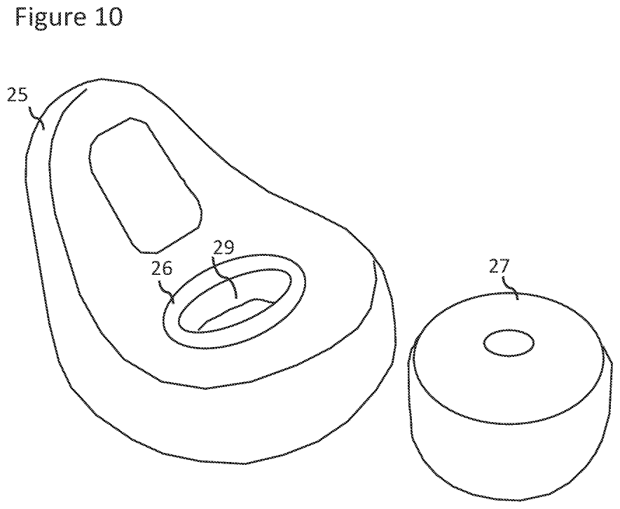

FIG. 10 shows a perspective view of an alternative embodiment of the mattress where the mattress 25 is shaped as an inflatable chair which may or may not include a footstool 27. In this embodiment, a continuous tube-shaped cushion 26 is attached or inserted in an opening 29 in the mattress. In other embodiments, there are multiple tube-shaped cushions that can be attached or inserted in an opening in the mattress to provide alternatives to fit persons of different sizes and shapes. The continuous tube-shaped cushion 26 is shown as toroidal or doughnut-like in structure but this is not intended to limit the shape of the cushion which could be round, square, rectangular, triangular, oval, or any regular or irregular shape that would fit the buttocks. The back of the mattress 25 has adjustable support based on how much the mattress 25 is inflated. The mattress may be self-inflating as discussed above. The continuous tube-shaped cushion 26 may be made of any conventional cushion material including foam, memory foam, sponge, or gel, or the continuous tube-shaped cushion may be inflatable.

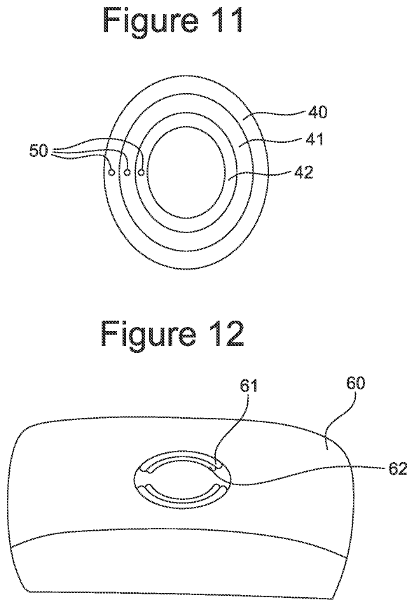

FIG. 11 shows a top view of three continuous tube-shaped cushions 40, 41, 42, each with a valve 50 to fill each cushion with air. These three continuous tube-shaped cushions 40, 41, 42 can be placed in the opening of a mattress of this invention, and different amounts of air can be pumped into the cushions to change their size, shape and firmness to accommodate the needs, fit, and comfort of different persons and their different sizes and shapes.

FIG. 12 shows an embodiment of this invention that is a mattress 60 that is an inflatable air mattress with one or more non-continuous tube-shaped cushions 61, 62. Cushion 61 is placed on one side of the opening in the mattress 60, while a mirror image of that cushion is placed on the other side of the opening in the mattress 60. Cushion 62 is likewise placed on the one side of the opening, while a mirror image cushion is placed on the opposite side of the opening of the mattress.

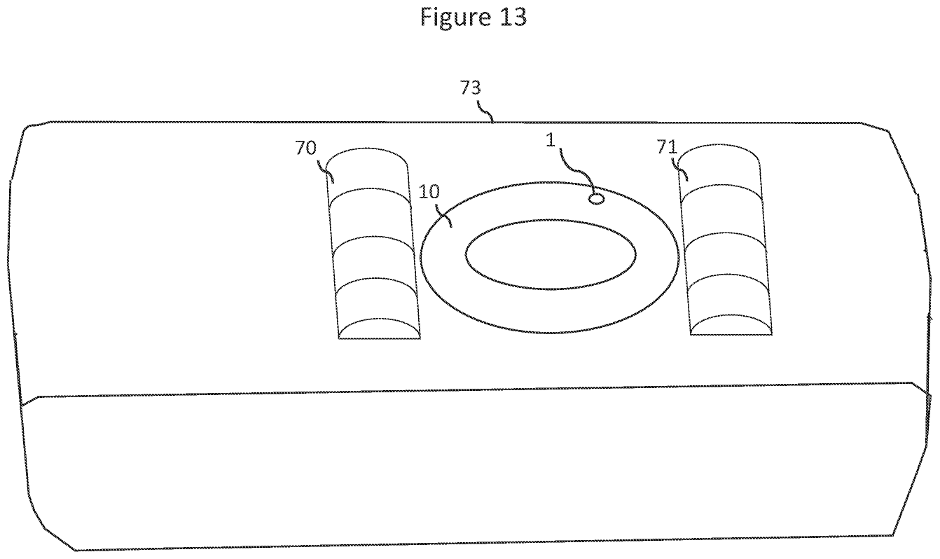

FIG. 13 shows an embodiment of this invention that is a mattress 73 that is an inflatable air mattress with a continuous tube-shaped cushion 10 with a valve 1 to fill the cushion with air. A lumbar support 70 is placed on the mattress. Likewise a thigh support 71 is placed on the opposite side of the opening of the mattress. The thigh support and lumbar support may be adjustable.

The subject matter of this disclosure is now described with reference to the following examples. These examples are provided for the purpose of illustration only, and the subject matter is not limited to these examples, but rather encompasses all variations which are evident as a result of the teaching provided herein.

### EXAMPLE 1

In this example, a mattress is provided for enabling a person to lie in a supine position or sit without putting excessive pressure on the buttocks area after gluteal surgery or some other procedure affecting the lower rear area of a human trunk. The mattress is of a size sufficient to support a substantial portion of the person. The mattress comprises (a) a main mattress section having an opening of a size to fit at least one tube-shaped cushion; and (b) at least one tube-shaped cushion which is located within the opening of the main mattress section.

The at least one tube-shaped cushion may be inflatable in certain embodiments. If it is inflatable, it may have at least one valve for inflating it. Such a valve should be placed in a position so as to not make the person using the mattress uncomfortable. In some embodiments, the at least one tube-shaped cushion is self-inflatable. In preferred embodiments the cushion is adjustable in its size, firmness and/or other properties so that it can be adjusted to provide better comfort for the person using it. In other preferred embodiments, a variety of cushions with different sizes, firmness and/or other properties is provided that each fit the mattress, which can be chosen to increase the comfort and fit for the person using it and be changed, if necessary, as the person's recovery progresses and/or needs change.

In the mattress embodiments of this example, the at least one tube-shaped cushion is inserted into the opening of the main mattress section by merely being placed therein. In other embodiments, the cushion is removably or permanently attached (e.g., using Velcro™, other hardware or other means) to the main mattress section. In other embodiments, the at least one tube-shaped cushion is permanently attached to the main mattress section. In preferred embodiments, the tube-shaped cushion is continuous (e.g., donut shaped without beginning or end).

In certain embodiments of this example, the mattress is inflatable, and in certain of these embodiments, the mattress is self-inflatable.

In certain embodiments of this example the mattress has an adjustable elevated back support and/or an adjustable elevated foot support. In certain embodiments of this example, the mattress has an adjustable lumbar support.

### EXAMPLE 2

In this example, a mattress is provided for enabling a person to lie in a supine position or sit without putting excessive pressure on the buttocks area after gluteal surgery or other procedures affecting the lower rear area of a human trunk. The mattress is of a size sufficient to support a substantial portion of the person. The mattress comprises: (a) a reversible main mattress section having a first side and a second side; (b) the main mattress section first side having an opening of sufficient size to allow the buttocks of the person to descend into the opening; and (c) the main mattress section second side having a larger opening than the main mattress section first side, the larger opening of the main mattress section second side being of sufficient size to allow the buttocks of another, larger person to descend into the opening when the mattress is turned over.

In certain embodiments, the main mattress section first side opening has at least one tube-shaped cushion. In certain preferred embodiments of these, the tube-shaped cushion is continuous (e.g., forming a donut shape or round shape without beginning or end). These cushions may preferably add between about 0.5 to about 6.0 inches to the opening in the mattress, and more preferably about 1.0 to about 3.0 inches to the opening in the mattress, and most preferably about 2 inches to the opening in the mattress. In other preferred embodiments, the tube-shaped cushions are not continuous and multiple cushions are used (e.g., one or more on the left side of the patient and one or more on the right side of the patient; one or more on the front of the patient and one or more on the back of the patient) and they are each not continuous but instead each cushion has at least two ends.

In certain alternative embodiments, there are multiple tube-shaped cushions that are available to be all used together, or, for some applications only some of them are used together, in order to better fit the person after their surgery or other procedure. These cushions can be filled with air, liquid, or any other substance and have single or multiple compartments and/or channels. In certain of these embodiments, the multiple cushions can be adjustable by, for example, adding or subtracting air or liquid from them. Thus, a series of such cushions can be used that fit within each other and/or the mattress and they can be adjusted in size, shape and/or other properties (e.g., firmness) to better fit the person and their needs. The shape of such cushions also can be the same or can differ to provide a better fit for the person using the mattress.

In still other alternative embodiments, the tube-shaped cushions can have multiple tubing layers that can be used. These cushions can be filled with air, liquid, or any other substance and have single or multiple compartments and/or channels. In certain of these embodiments, the different tubing layers can be inflated or filled separately to provide additional methods to adjust their fit and application to individual patients.

In certain embodiments, instead of separate tube-shaped cushions, the mattress has separate layers, compartments and/or channels in the opening that can be each separately filled with air and/or liquid and/or any other substance to adjust them to the particular person and their needs.

The tube-shaped cushion may be inflatable in certain embodiments. If it is inflatable, it may have at least one valve for inflating it. It may also have multiple valves and multiple channels or compartments to increase its ability to be adjusted for particular patients. Such a valve should be placed in a position so as to not make the person using the mattress uncomfortable. In some embodiments, the tube-shaped cushion is self-inflatable. In preferred embodiments the cushion is adjustable in its size, firmness and/or other properties so that it can be adjusted to provide better comfort for the person using it. In other preferred embodiments, a variety of cushions with different sizes, firmness and/or other properties is provided that each fit the mattress, which can be chosen to increase the comfort and fit for the person using it and be changed, if necessary, as the person's recovery progresses and/or needs change.

In the mattress embodiments of this example, the tube-shaped cushion is inserted into the opening of the main mattress section first side by merely being placed therein. In other embodiments, the cushion is attached (e.g., using Velcro™, other hardware or other means) to the main mattress section first side. In other embodiments, the tube-shaped cushion is permanently attached to the main mattress section first side.

In certain embodiments of this example, the mattress is inflatable, and in certain of these embodiments, the mattress is self-inflatable.

In certain embodiments of this example the mattress has an adjustable elevated back support and/or an adjustable elevated foot support. In certain embodiments of this example, the mattress has an adjustable lumbar support.

### EXAMPLE 3

In this example, a mattress is provided for enabling a person to lie in a supine position or sit without putting excessive pressure on the buttocks area after gluteal surgery or other procedures affecting the lower rear area of a human trunk. The mattress is of a size sufficient to support a substantial portion of the person. The mattress comprises: (a) a reversible main mattress section having a first side and a second side; (b) the main mattress section first side having an opening of a sufficient size to fit at least one continuous tube-shaped cushion; (c) at least one continuous tube-shaped cushion which is located within the opening of the main mattress section first side; and (d) the main mattress section second side having a larger opening than the opening of the main mattress section first side and being of sufficient size to allow the buttocks of another, larger person to descend into the opening when the main mattress section second side is facing upwards.

The at least one continuous tube-shaped cushion may be inflatable in certain embodiments. If it is inflatable, it may have at least one valve for inflating it. Such a valve should be placed in a position so as to not make the person using the mattress uncomfortable. In some embodiments, it is self-inflatable. In preferred embodiments the cushion is adjustable in its size, firmness and/or other properties so that it can be adjusted to provide better comfort for the person using it. In other preferred embodiments, a variety of cushions with different sizes, firmness and/or other properties is provided that each fit the mattress, which can be chosen to increase the comfort and fit for the person using it and be changed, if necessary, as the person's recovery progresses and/or needs change.

In the mattress embodiments of this example, the at least one tube-shaped cushion is inserted into the opening of the main mattress section by merely being placed therein. In other embodiments, the cushion is removably or permanently attached (e.g., using Velcro™, other hardware or other means) to the main mattress section. In other embodiments, the at least one tube-shaped cushion is permanently attached to the main mattress section.

In certain embodiments of this example, the mattress is inflatable, and in certain of these embodiments, the mattress is self-inflatable.

In certain embodiments of this example, the mattress has an adjustable elevated back support and/or an adjustable elevated foot support. In certain embodiments of this example, the mattress has an adjustable lumbar support.

In certain embodiments of this example, the mattress has a lumbar support and a thigh support which may be adjustable.

Although there has been shown and described the preferred embodiments of the present invention, it will be readily apparent to those skilled in the art that modifications may be made thereto which do not exceed the scope of the appended claims. Therefore, the scope of the invention is only to be limited by the following claims.

We claim:

1. A mattress for enabling a person to lie in a supine position or sit without putting excessive pressure on the buttocks area after gluteal surgery or other procedures affecting the lower rear area of a human trunk, said mattress of a size sufficient to support a substantial portion of the person, which mattress comprises:
(a) a main mattress section having an opening of a size to fit at least one tube-shaped cushion; and
(b) at least one tube-shaped cushion which is located within the opening of the main mattress section.

2. The mattress of claim 1 wherein the at least one tube-shaped cushion is continuous.

3. The mattress of claim 1 wherein the at least one tube-shaped cushion is inflatable.

4. The mattress of claim 3 wherein the at least one tube-shaped cushion has at least one valve for inflating the tube-shaped cushion.

5. The mattress of claim 3 wherein the at least one tube-shaped cushion is self-inflatable.

6. The mattress of claim 1 wherein the at least one tube-shaped cushion is inserted into the opening of the main mattress section by merely being placed therein.

7. The mattress of claim 1 wherein the at least one tube-shaped cushion is removably attached to the main mattress section.

8. The mattress of claim 1 wherein the at least one tube-shaped cushion is permanently attached to the main mattress section.

9. The mattress of claim 1 wherein the mattress is inflatable.

10. The mattress of claim 1 wherein the mattress is self-inflatable.

11. The mattress of claim 1 wherein the mattress has an adjustable elevated back support.

12. The mattress of claim 1 wherein the mattress has an adjustable elevated foot support.

13. The mattress of claim 1 wherein the mattress has an adjustable elevated back support and an adjustable elevated foot support.

14. The mattress of claim 1 wherein the mattress has a lumbar support which may be adjustable.

15. The mattress of claim 1 wherein the mattress has a thigh support which may be adjustable.

16. A mattress for enabling a person to lie in a supine position or sit without putting excessive pressure on the buttocks area after gluteal surgery or other procedures affecting the lower rear area of a human trunk, said mattress of a size sufficient to support a substantial portion of the person, which mattress comprises:
(a) a reversible main mattress section having a first side and a second side;
(b) the main mattress section first side having an opening of sufficient size to allow the buttocks of the person to descend into the opening; and
(c) the main mattress section second side having a larger opening than the main mattress section first side, the larger opening of the main mattress section second side being of sufficient size to allow the buttocks of another, larger person to descend into the opening when the mattress is turned over.

17. The mattress of claim 16 wherein the mattress is inflatable.

18. The mattress of claim 16 wherein the mattress is self-inflatable.

19. The mattress of claim 16 wherein the opening for at least the main mattress section first side includes at least one tube-shaped cushion.

20. The mattress of claim 16 wherein the opening for at least the main mattress section first side includes at least one continuous tube-shaped cushion.

21. A mattress for enabling a person to lie in a supine position or sit without putting excessive pressure on the buttocks area after gluteal surgery or other procedures affecting the lower rear area of a human trunk, said mattress of a size sufficient to support a substantial portion of the person, which mattress comprises:
(a) a reversible main mattress section having a first side and a second side;
(b) the main mattress section first side having an opening of a size to fit at least one tube-shaped cushion;
(c) at least one tube-shaped cushion which is located within the opening of the main mattress section first side;
(d) the main mattress section second side having a larger opening than the opening of the main mattress section first side and being of sufficient size to allow the buttocks of a second, larger person to descend into the opening when the main mattress section second side is facing upwards.

22. The mattress of claim 21 wherein the at least one tube-shaped cushion is inflatable.

23. The mattress of claim 21 wherein the at least one tube-shaped cushion has at least one valve for inflating the continuous tube-shaped cushion.

24. The mattress of claim 21 wherein the at least one tube-shaped cushion is self-inflatable.

25. The mattress of claim 21 wherein the at least one tube-shaped cushion is inserted into the opening of the main mattress section by merely being placed therein.

26. The mattress of claim 21 wherein the at least one tube-shaped cushion is removably attached to the main mattress section.

27. The mattress of claim 21 wherein the at least one tube-shaped cushion is permanently attached to the main mattress section.

28. The mattress of claim 21 wherein the mattress is inflatable.

29. The mattress of claim 21 wherein the mattress is self-inflatable.
